(19) United States
(12) Patent Application Publication
(10) Pub. No.: US 2005/0278994 A1
(43) Pub. Date: Dec. 22, 2005

(54) Method of and apparatus for displaying items

(76) Inventor: Clester H. Evans JR., Dallas, TX (US)

Correspondence Address: JENKENS & GILCHRIST, PC, 1445 ROSS AVENUE, SUITE 3200, DALLAS, TX, 75202, US

(21) Appl. No.: 11/147,885

(22) Filed: Jun. 8, 2005

Related U.S. Application Data
(60) Provisional application No. 60/582,243, filed on Jun. 22, 2004.

(51) Int. Cl. G09F 1/00

(52) U.S. Cl. 40/124.17; 40/124.09

(57) ABSTRACT

A method and assembly for greeting card display including forming the greeting card with a removable card-holding region having at least a pair of slots. The removable region may be separated from the greeting card and folded as well as unfolded to define a greeting card display assembly. The greeting card itself is inserted into the slots of the partially unfolded removable region of the display for the support of the card in a variety of positions.

### CROSS REFERENCE TO RELATED APPLICATION

This application claims the benefit of, and incorporates by reference the entirety of U.S. Provisional Patent Application No. 60/582,243 filed Jun. 22, 2004.

### BACKGROUND OF THE INVENTION

1. Field of the Invention

The present invention relates to displayable items such as, greeting cards, Christmas cards, photographs, plaques, announcements, etc. and, more particularly, but not by way of limitation, to a method of and apparatus for displaying such displayable items by the owner or recipient thereof.

2. History Related Art

The popularity and use of greeting cards are well established in world-wide commerce. The term greeting card as used herein, includes Christmas, Easter, Valentine and other holiday/special occasion cards as well as announcements and related types of “greeting” information that is sent by first party to a second party. In the main, the sending party will utilize the postal service to mail the greeting card to the receiving party. In some instances, however, the first party will simply purchase the greeting card and deliver it to the second party. In either case, the greeting card itself is typically a folded member bearing indicia such as photographs, greetings, stories, jokes, drawings, and similar subject matter that may be of interest to the receiving party or convey emotion from the sending party. For this reason, the greeting card industry has boomed in recent decades. Greeting cards are now found in grocery stores, specialty card stores, gift shops, and virtually all other areas of commerce. The style, shape and sentiment of greeting cards will of course vary, as discussed above. In that regard, many commercial establishments even categorize greeting cards by sentiment such as birthday, graduation, holidays, so as to facilitate the ease in review and purchase by the user.

One of the most popular times for the sending of greeting cards is in December. Christmas is a significant holiday around the world for which cards are sent by the millions. Once a greeting card is received by a person, the display of the greeting card, is often limited to various common display techniques. For example, Christmas cards are often left laying on a table top or hung on a decorative ribbon. In the latter case, the attachment technique between the ribbon and the card is of course an area of creativity. Nonetheless, clips and paste are commonly used. Sometimes folded Christmas cards are allowed to stand up in the folded condition in which they were sent. It is not unusual, however, for a horizontally-folded Christmas card to eventually unfold and lose its upright condition. Christmas cards vertically folded do not have this particular problem. The display of greeting cards is, however, limited in many instances due to the lack of time or creativity on the part of the recipient to display cards in meaningful ways.

When greeting cards are particularly artistic and/or worthy of display, it may be somewhat frustrating to both the sender and/or the recipient for the card to not be properly mounted for viewing by third parties. Artistic work appearing on a greeting card should, for example, be seen and enjoyed by those who would appreciate it. For this reason, greeting cards (including single page, unfolded, photographs and related items) could be displayed in a meaningful fashion if a display system were provided therewith. The present invention addresses such aspects by providing a method and system for facilitating the display of greeting cards by the recipient for the purpose of exposing the greeting card to others.

### BRIEF SUMMARY OF THE INVENTION

The present invention relates to greeting cards. More particularly, one aspect of the invention relates to a greeting card having a removable card-holding region. The card-holding region is adapted for separation from the greeting card and is formed with at least a pair of oppositely disposed slots allowing the greeting card to be placed therein once the removable region is folded into position. In this manner, greeting cards can be advantageously displayed to the delight of the recipient with a removable region that functions as a card stand.

In another embodiment, the present invention relates to a greeting card having a folded member on the rear surface thereof, the folding member adapted for extending outwardly therefrom for support thereof. The folding member may, in one embodiment, be formed of material similar to that of the greeting card, although not necessarily limited to that type of material, and mounted thereto to form a base against which the greeting card can lean for stabilized display.

In another embodiment, the present invention relates to a greeting card display assembly comprising a greeting card constructed with a removable card-holding region, the card region having at least a pair of slots and adapted for being folded after removal from the greeting card so that the slots are generally aligned one with the other to define a fold line therebetween and whereby the folded removable region may be partially unfolded into a display position with the slots disposed on the opposite sides of the fold line for receipt of the greeting card therein and the display thereof. In another embodiment the slots of the partially unfolded removable region are adapted to facilitate the upright display of the greeting card. In another embodiment the folded removable region may be unfolded into an angle greater than 90 degrees and less than 180 degrees for support of the greeting card.

In another embodiment, the present invention relates to a method of displaying greeting cards comprising the steps of: forming the greeting card with a removable card-holding region having at least a pair of slots, separating the removable region from the card, folding the separated removable region so that the slots are generally aligned one with the other and defining a fold line therebetween, partially unfolding the folded removable region into a display position with the slots disposed on the opposite sides of the fold line for receipt of the greeting card therein and inserting the greeting card into the slots of the partially unfolded removable region for the display thereof.

The method described above may also include the step of inserting the greeting card into the slots of the partially unfolded removable region facilitates the upright display of the greeting card. Additionally, the method may include the step of partially unfolding the folded removable region includes the step of unfolding the folded removable region into an angle greater than 90 degrees. The step of unfolding the folded removable region may include the step of unfolding the folded removable region into an angle less than 180 degrees.

The method described above may also include the step of forming the removable card-holding region from the same material as the greeting card. Additionally the method may include the step of providing a serration region between the greeting card and the card-holding region. In one embodiment, the step of forming the greeting card with a removable card-holding region includes the step of forming the removable card-holding region of the material different from that of the greeting card.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a perspective view of a greeting card constructed in accordance with one aspect of the present invention and including a card stand of the type adapted to be removed from the greeting card by the recipient for facilitating the display thereof in accordance with an embodiment of the present invention;

FIG. 2 is an alternative embodiment of the present invention wherein the card stand region is disposed along a single section of the card;

FIG. 3 is the card stand region of FIG. 1 removed therefrom;

FIG. 4 is the card stand region of FIG. 2 removed therefrom;

FIG. 5 illustrates the folded card stand of FIG. 3;

FIG. 6 illustrates the folded card stand of FIG. 4;

FIG. 7 is a perspective view of the greeting card of FIG. 1 after the removal of the card stand region and its mounting upon the folded card stand of FIG. 5;

FIG. 8 is a perspective view of the greeting card of FIG. 2 after the removal of the card stand region and its mounting upon the folded card stand of FIG. 6;

FIG. 9 is a perspective view of another embodiment of the present invention wherein a greeting card is supported by a base member secured to the rear surface thereof and folded outwardly therefrom for supporting the greeting card in a display mode;

FIG. 10 is an alternative embodiment of the present invention wherein a single section card includes a card stand illustrated in support thereof; and

FIG. 11 is an alternative embodiment of the card of FIG. 2 of the present invention wherein the card stand region extends all the way across the bottom of the card to provide a larger folded card stand than that shown in FIG. 4.

### DETAILED DESCRIPTION OF THE INVENTION

It has been found advantageous to provide a method and system for the display of greeting cards that includes a card stand region provided therewith. In one embodiment, the card stand region is removable from the greeting card and adapted to be folded to allow the greeting card to be placed thereon and stabilized therewith. And in another embodiment, the mounting member is affixed to the rear surface of the greeting card and forms a base once it is extended outwardly therefrom. In this way the utilization of a simple, lightweight, inexpensive card stand can enhance the viewing of greeting cards and the like. In accordance with certain embodiments of the present invention, greeting card display members are provided in a variety of designs that facilitate variations in upstanding presentations of the greeting cards by the recipient. In one embodiment, the greeting card itself contains a scored or perforated region that may be removed and appropriately folded as indicated thereon to support a greeting card placed thereon in a configuration enhancing display.

Referring first to FIG. 1 there is shown one embodiment of a greeting card 10 constructed in accordance with the principles of the present invention. The greeting card 10 contains a greeting card body portion 12 that is horizontally folded along a line 14 to therein generally bifurcate the greeting into two sections. A lower region 16 of the greeting card is constructed with a perforated portion 18, facilitating separation of the perforated portion 18, to thereby form a greeting card stand as shown and described in more detail below.

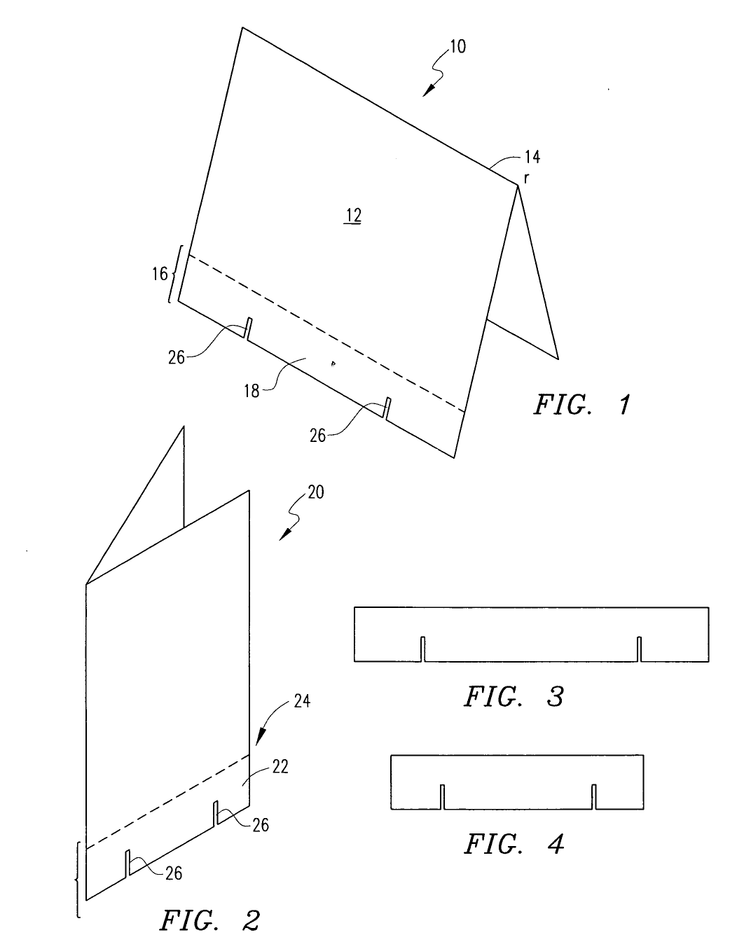

Referring now to FIG. 2, there is shown an alternative embodiment of the greeting card of FIG. 1, wherein a greeting card 20 has a perforated section 22, forming a stand region, disposed at a lower region 24 of one side of the vertically folded greeting card 26. The perforated section may extend across the entire lower region of the card 26, as shown in FIG. 11. The perforated sections 18 and 22 are removable from the greeting card to subsequently form a greeting card stand for the upstanding display thereof and are formed with slots 26 to support the greeting card.

FIGS. 3 through 8 illustrate various aspects and alternative embodiments of the present invention. It may be seen in reviewing FIGS. 3 through 8 that what is provided herein is a method of and assembly for displaying greeting cards. The method comprises the steps of forming the greeting card with a removal card-holding region having at least a pair of slots. This aspect is clearly seen in each of the FIGS. 3 through 8, where it is also seen that the removable card-holding region is separable from the card. By folding the separated removable region so that the slots are generally aligned one with the other, they therein define a fold line therebetween. By partially unfolding the folded removable region into a display position with the slots disposed on the opposite sides of the fold line for receipt of the greeting card, the greeting card may be easily inserted into the partially unfolded removable region for the display thereof. This aspect is most clearly seen in FIGS. 7 and 8. What is also illustrated in FIGS. 7 and 8 are the alternative embodiments of the greeting card assembly as herein illustrated and further defined whereby the greeting cards may be displayed in an upright position with the fold line generally vertical as in FIG. 8 or in the generally-horizontally folded configuration shown in FIG. 7. In this manner, a variety of greeting cards, such as drawings, pictures, poems, Christmas cards and other holiday cards, and/or other stylized aspects can be shown and displayed.

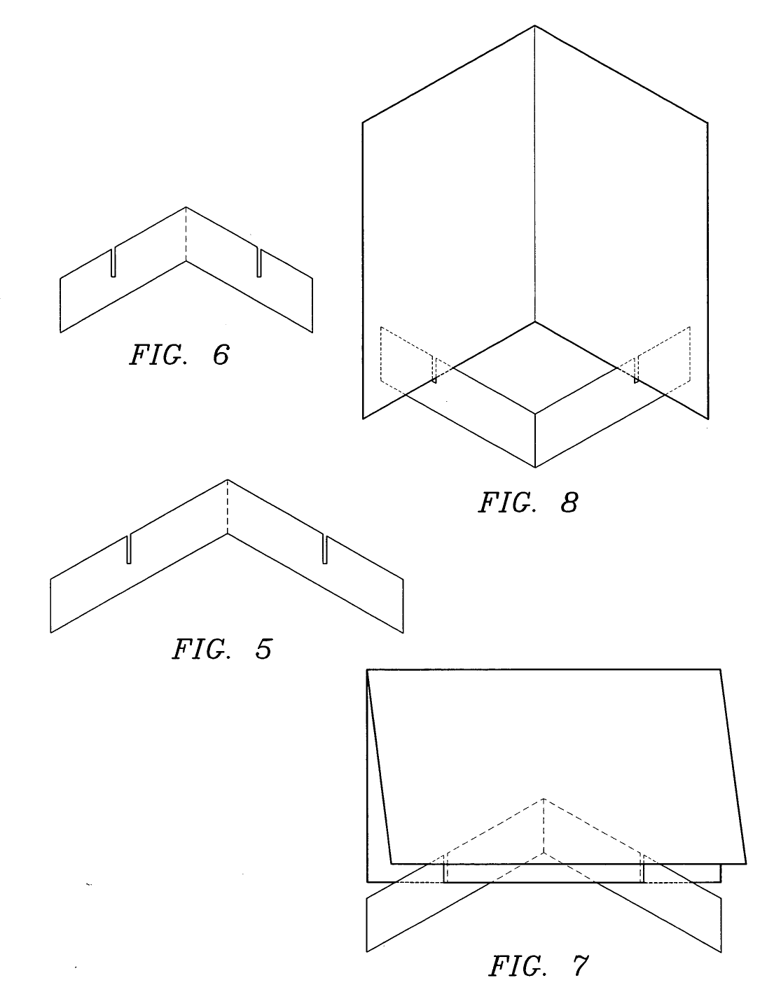

Still referring to FIGS. 3 through 8 in combination, the step of partially unfolding the folded removable region of the greeting cards generally includes the step of unfolding the folded removable region into an angle greater than 90 degrees. That particular angular variety is clearly shown in FIGS. 5 and 6. As also shown in FIGS. 5 and 6, the unfolding of the folded removable region includes the step of unfolding the folded removable region into an angle less than 180 degrees. Obviously, at 180 degrees, the folded removable region would no longer be folded. It is for this reason that it is presented that the folded removable region may be unfolded into an angle on the order of 120 to 140 degrees. This range is provided for purposes of example only and is in no way limiting within the spirit and scope of the present invention.

Referring still to FIGS. 3 through 8, the removable card-holding region may include a serration region between the greeting card and the card-holding region. This potential serration is most clearly shown in FIG. 1, and the removed card-holding region most clearly shown in the drawings referred to in this portion of the description. By way of example, the removable card-holding region may also be formed of a material different than that of the greeting card, or the same as that of the greeting card. It is further noted that the method of displaying the greeting card may also include the step of temporarily securing the removable card-holding region to the greeting card by bonding, instead of serration. As shown in these drawings, the removable card-holding region can be disposed along the bottom or along a lower end portion of the greeting card. The exact location of the removable card-holding region can, in fact, be along any exposed edge of the greeting card, and the location of the removable card-holding region should, without limitation, be in no way exclusive to that specifically set forth and shown herein. The exact location of the removable card-holding region relative to the greeting card is not a limiting aspect of the present invention.

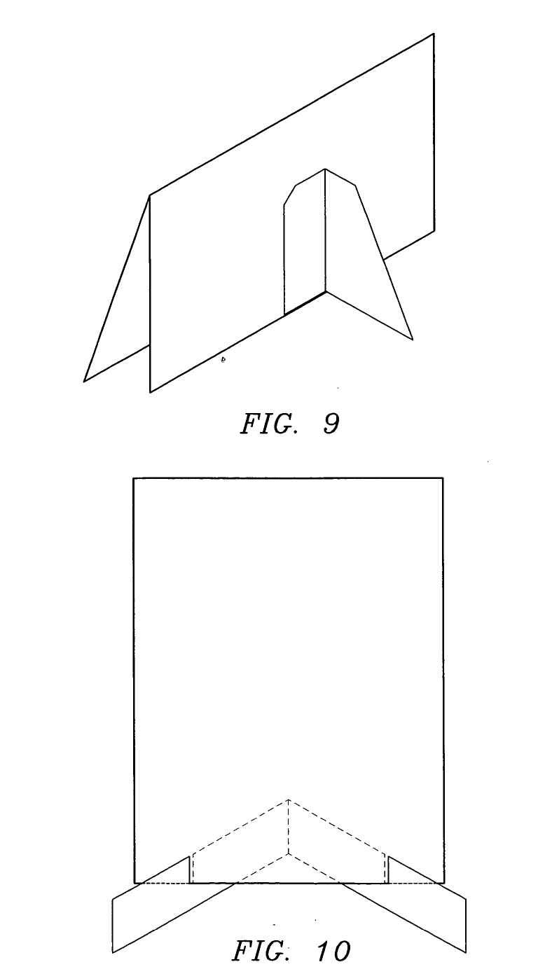

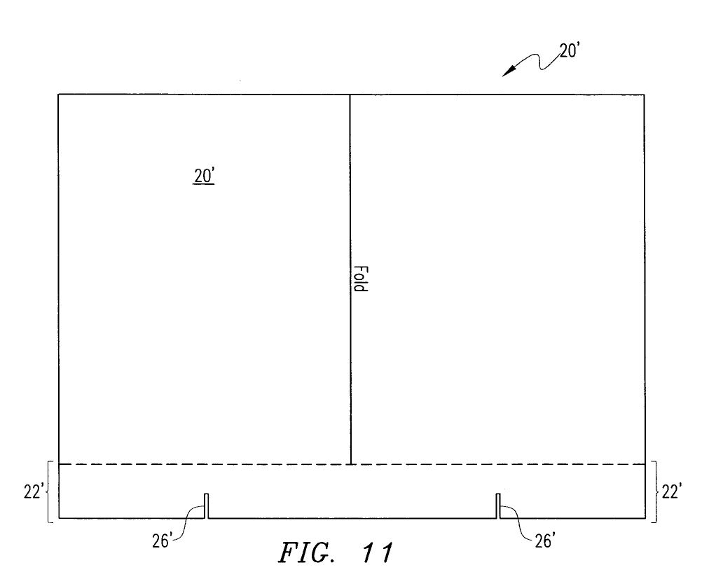

FIG. 9 is an alternative embodiment of the greeting card display system and method of the present invention. In this particular embodiment, a flap is foldably mounted to the rear of a greeting card in such a manner so as to easily facilitate its folded position outwardly therefrom. In this position, the greeting card can be oriented in an angled configuration so that the greeting card is in a full display of a particular surface thereof. It may be seen that the flap may be comprised of cardstock similar to that from which the greeting card is fabricated. FIG. 10 illustrates yet another aspect of the invention wherein a single section card includes a pre-formed method and system for display so that the essence of the greeting card can be easily presented by the greeting card recipient in accordance with the present invention as described in FIGS. 1-9.

FIG. 11 illustrates the flat pattern of an unfolded card 20′ of the type shown in FIG. 2, but with the stand region 22′ is disposed across the entire base of the card 20′. Two slots 26′ are formed, one on each side of the fold line as shown.

In summary, the present invention may be fabricated from cardstock and/or other kinds of material that would provide more permanency. Plastics, metals, wood, glass and other related materials are contemplated. Moreover, the size of the various cards constructed in accordance with the invention could be larger or smaller than that which is conventional. Size and materials may thus vary.

It is thus believed that the operation and construction of the present invention will be apparent from the foregoing description of the preferred embodiments. While the configurations and designs as shown are described as being preferred, it will be obvious to a person of ordinary skill in the art that various changes and modifications may be made therein without departing from the spirit and scope of the invention, as defined in the following claims. Therefore, the spirit and the scope of the appended claims should not be limited to the description of the preferred embodiments contained herein.

1. A method of displaying greeting cards comprising the steps of:
forming the greeting card with a removable card-holding region having at least a pair of slots;
separating the removable region from the card;
folding the separated removable region so that the slots are generally aligned one with the other and defining a fold line therebetween;
partially unfolding the folded removable region into a display position with the slots disposed on the opposite sides of the fold line for receipt of the greeting card therein; and
inserting the greeting card into the slots of the partially unfolded removable region for the display thereof.

2. The method as set forth in claim 1 wherein the step of inserting the greeting card into the slots of the partially unfolded removable region facilitates the upright display of the greeting card.

3. The method as set forth in claim 1, wherein the step of partially unfolding the folded removable region includes the step of unfolding the folded removable region into an angle greater than 90 degrees.

4. The method as set forth in claim 3, wherein the step of unfolding the folded removable region includes the step of unfolding the folded removable region into an angle less than 180 degrees.

5. The method as set forth in claim 4, wherein the step of unfolding the folded removable region includes the step of unfolding the folded removable region into an angle on the order of 120-140 degrees.

6. The method as set forth in claim 1, wherein the step of forming the greeting card includes forming the removable card-holding region from the same material as the greeting card.

7. The method as set forth in claim 6, wherein the step of forming the removable card-holding region includes the step of folding the removable region onto the greeting card to maintain the original greeting card shape thereof.

8. The method as set forth in claim 6, wherein the step of forming the greeting card with a removable card-holding region includes the step of providing a serration region between the greeting card and the card-holding region.

9. The method as set forth in claim 1, wherein the step of forming the greeting card with a removable card-holding region includes the step of forming the removable card-holding region of the material different from that of the greeting card.

10. The method as set forth in claim 1, further including the step of temporarily securing the removable card-holding region to the greeting card by bonding.

11. The method as set forth in claim 1, wherein the step of forming the greeting card with a removable card-holding region includes the step of disposing the removable card-holding region on a lower end portion of the greeting card.

12. The method as set forth in claim 11, and further including disposing the removable card-holding region at the bottom of the greeting card.

13. The method as set forth in claim 1, wherein the greeting card comprises a Christmas card.

14. The method as set forth in claim 1, wherein the greeting card comprises an announcement.

15. The method as set forth in claim 14, wherein the greeting card comprises a picture.

16. A greeting card display assembly comprising a greeting card constructed with a removable card-holding region, the card-holding region having at least a pair of slots and adapted for being folded after removal from the greeting card so that the slots are generally aligned one with the other to define a fold line therebetween and whereby the folded removable region may be partially unfolded into a display position with the slots disposed on the opposite sides of the fold line for receipt of the greeting card therein and the display thereof.

17. The assembly as set forth in claim 16 wherein the slots of the partially unfolded removable region are adapted to facilitate the upright display of the greeting card.

18. The assembly as set forth in claim 16, wherein the step of partially unfolding the folded removable region includes the step of unfolding the folded removable region into an angle greater than 90 degrees.

19. The assembly as set forth in claim 18, wherein the folded removable region may be unfolded into an angle less than 180 degrees for support of the greeting card.

20. The assembly as set forth in claim 19, wherein the folded removable region is adapted to be unfolded into an angle on the order of 120-140 degrees.

21. The assembly as set forth in claim 16, wherein the removable card-holding region is formed from the same material as the greeting card.

22. The assembly as set forth in claim 21, wherein the card-holding region is folded onto the greeting card to maintain the original greeting card shape thereof.

23. The assembly as set forth in claim 21, wherein-holding region includes a serration disposed between the greeting card and the card-holding region.

24. The assembly as set forth in claim 16, wherein removable card-holding region is formed of a material different from that of the greeting card.

25. The assembly as set forth in claim 16, wherein the removable card-holding region is attached to the greeting card by bonding.

26. The method as set forth in claim 16, wherein the removable card-holding region is disposed on a lower end portion of the greeting card.

27. The method as set forth in claim 26, wherein the removable card-holding region is disposed at the bottom of the greeting card.

28. The assembly as set forth in claim 16, wherein the greeting card comprises a Christmas card.

29. The assembly as set forth in claim 16, wherein the greeting card comprises an announcement.

30. The assembly as set forth in claim 16, wherein the greeting card comprises a picture.
